(19) United States
(12) Patent Application Publication
(10) Pub. No.: US 2003/0062346 A1
(43) Pub. Date: Apr. 3, 2003

(54) Method of vacuum holes formation on carrier film of chemical mechanical polishing machine

(75) Inventors: Sheng-Hun Jeng, Hsinchu (TW); Lu-Lang Hsu, Yunlin Hsien (TW)

Correspondence Address: DOUGHERTY & TROXELL, SUITE 1404, 5205 LEESBURG PIKE, FALLS CHURCH, VA, 22041, US

(73) Assignee: ASIA IC MIC-PROCESS, Inc.

(21) Appl. No.: 09/964,744

(22) Filed: Sep. 28, 2001

(51) Int. Cl. B23K 26/38

(52) U.S. Cl. 219/121.71

(57) ABSTRACT

A method of vacuum holes formation on carrier film of chemical mechanical polishing machine; the formed vacuum is to fit the dimension and position of vacuum hole on the wafer carrier of the chemical mechanical polishing machine. The present invention is that providing a formed plate and a mold for fixing and positioning, and then adjusting to produce the best laser parameters, thus forming vacuum hole of need of carrier film on chemical polishing machine via laser machine.

### 1. FIELD OF THE INVENTION

This invention is about a method of vacuum hole formation of carrier film on chemical mechanical polishing machine, especially about the method of vacuum hole formation of carrier film by laser machine.

### 2. BACKGROUND OF THE INVENTION

For the recent years, each integrated circuit company in order to decrease running cost and increase the product competitiveness, the packing density of integrated circuit is increasing rapidly. To increase the packing density of integrated circuit, not only the component size has to be decreased, the distance between components must also be shortened. To reach the aforesaid object, each layer of integrated circuit has to reach global planarization. Recently the rapid development of chemical mechanical polishing (CMP) is to reach the object of global planarization. Even we can say the CMP development is the key technology of rapid increasing of integrated circuit packing density.

The CMP usually places a polishing pad on the circular polishing table, then uses a wafer carrier to press the wafer on the polishing pad with slurry to reach the CMP effect by relative motion between the wafer and the polishing pad.

The aforesaid wafer carrier is usually composed of stainless steel or special ceramic material with thickness between 1 and 1.5 inches. There are plural vacuum holes on the wafer carrier and fix the semiconductor wafer on the aforesaid wafer carrier by vacuum force. Besides, in order to make sure the good contact between semiconductor wafer and polishing pad to reach uniform chemical mechanical polishing, an insert film is usually needed between wafer and wafer carrier. The aforesaid carrier film function is to make sure there will be no horizontal motion of wafer during the CMP polishing process.

To use the vacuum force to fix the wafer on the carrier, the carrier film between must have relative vacuum holes toward carrier. The size, position of the aforesaid vacuum holes must be the same with those on wafer carrier and there can't be any unevenness on the aforesaid carrier film after formation of the vacuum holes on carrier film or the CMP flatness will be affected.

The prior art uses the mechanical boring to form the vacuum holes on the carrier film but the positions and sizes of the formed holes cannot be precisely controlled. What the serious is , the edge of the formed vacuum holes by mechanical boring is not flat and the glue on back of carrier film may have residue on the carrier film due to boring process and make pollution. During the CMP process, the aforesaid unevenness and generated particles will have large effect on the CMP flatness and decrease the yield ratio.

### SUMMARY OF THE INVENTION

The main object of this invention is to provide a method of vacuum holes formation on carrier film of chemical mechanical polishing machine.

Another object of this invention is to provide a sheath used to form the vacuum holes on the carrier film of chemical mechanical polishing machine, the aforesaid sheath is used on the laser-processing machine.

The main process of this invention is as follows: first provide a test carrier film and measure its appearance dimension. Prepare a plate, use the prior art to form a light passing window and three positioning holes on the aforesaid plate. Locate the aforesaid plate on the laser-processing machine and fix it. Use the prior art to form three pinholes, three up positioning holes and plural laser through holes on the aforesaid mold. Then forming three pins and three-cone type up position pins and fix the aforesaid three-cone type up position pins inside the aforesaid three up positioning holes. The aforesaid pinhole positions match the carrier film size. In the following laser process, the aforesaid three pins should be inserted into the three pin holes, fix the carrier film waiting for laser process on the aforesaid mold and make the aforesaid pins' top touch the aforesaid carrier film edge so that the positioning between the carrier film and the mold can be finished. The aforesaid three up positioning pins positions should match the three down positioning pins positions on the aforesaid plate for the following positioning between the aforesaid mold and plate. The aforesaid plural laser through holes positions include every possible vacuum hole position on the carrier film.

The following steps are to complete the whole laser process system and to adjust the laser parameters. Firstly insert the three pins into the three holes and fix the aforesaid testing carrier film on the aforesaid mold and make the aforesaid pins' top touch the aforesaid carrier film edge so that the positioning between the carrier film and the mold can be finished. Then insert the up position pins of the aforesaid mold into the down position holes of the plate to complete the positioning between the aforesaid mold and the plate.

Then start the laser, adjust the laser parameters, and do laser processing. After finishing, check the vacuum hole dimension and check surface process condition. If necessary, the laser processing and dimension/surface check steps must be repeated to get the best dimension/surface check result. And find out the optimal laser process parameter in this step. After adjusting the laser parameters, remove the aforesaid test carrier film and replace with the real carrier film on which vacuum holes will be formed for laser process, and do the process to form plural vacuum holes on the carrier film. The method of vacuum holes formation on carrier film of chemical mechanical polishing machine in this invention is finished.

### BRIEF DESCRIPTION OF THE DRAWINGS

FIG. 1 is the illustration showing the formed plate in this invention.

FIG. 2 is the illustration showing the formed mold in this invention.

FIG. 3 is the illustration showing the entire set up laser process instruments.

FIG. 4 is the illustration showing the formed vacuum holes on the carrier film in this invention.

### DETAILED DESCRIPTION OF THE PREFERRED EMBODIMENT

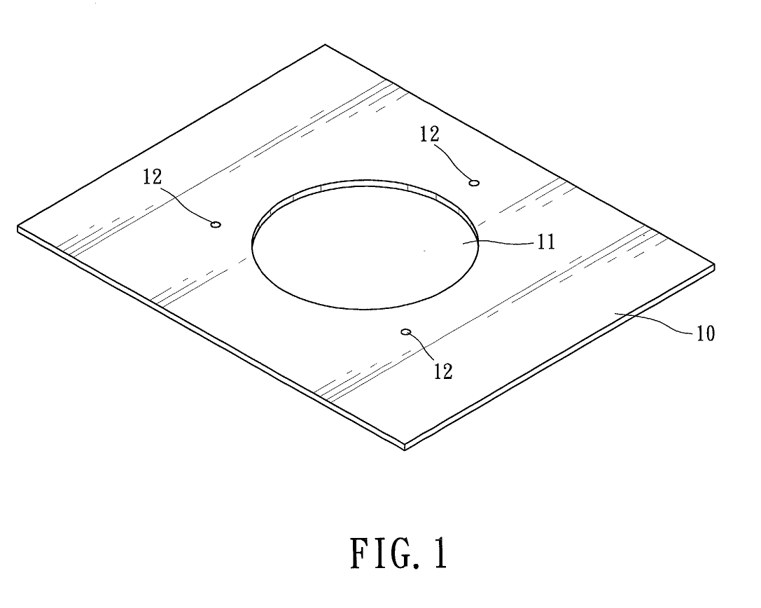

This invention is about a method of vacuum holes formation on carrier film of chemical mechanical polishing machine. First provide a test carrier film and measure its appearance dimension. The aforesaid carrier film appearance dimension depends on the real application; if it's applied on the 8-inches wafer CMN, the diameter should be a little larger than 8 inch and the thickness is between 0.5 to 2 mm. Then please refer to FIG.1, prepare a plate 10, use the prior art to form a light passing window 11 and three down position holes 12 on the aforesaid plate. Fix the aforesaid plate 10 on the laser process machine. The aforesaid light-passing window 11 is circle structure, the diameter is less than the carrier film's diameter, while its diameter should be large enough to cover the vacuum holes area on the carrier film. The aforesaid three down position holes 12 function is for further positioning.

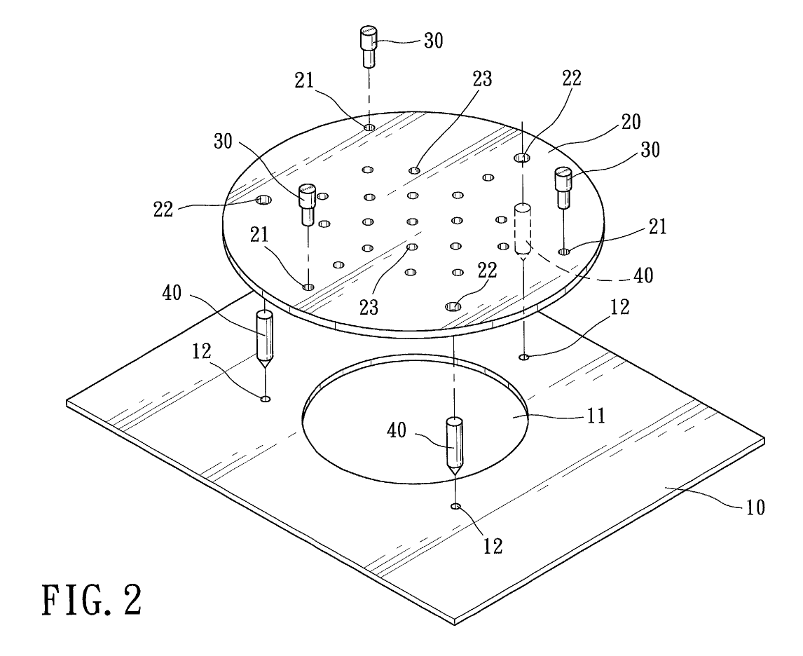

Please refer to FIG. 2, the following step is to form a mold 20. The aforesaid mold 20 is circle structure with thickness about 0.2 to 0.5 inches. Use the prior art to form three pinholes 21, three up position holes 22 and plural laser through holes 23 on the aforesaid mold. Then form three pins 30 and three cone type up position pins 40 and fix the aforesaid three up position pins 40 inside the aforesaid three up position holes 22, as shown on FIG.2. the aforesaid pin hole position 21 is to match the carrier film size, in the following laser process, the aforesaid three pins 30 should be inserted into the three pin holes 21 and fix the carrier film waiting for laser process on the aforesaid mold 20 and make the aforesaid three pins top touch the aforesaid carrier film edge so that the positioning between the carrier film and the mold 20 can be finished. The aforesaid three up positioning pins 40 positions should match the three down positioning pins 12 positions on the aforesaid plate 10 for the following positioning between the aforesaid mold 20 and plate 10. The aforesaid plural positions of laser through holes 23 include every possible vacuum hole position on the carrier film.

What the important is the positioning between the aforesaid carrier film and the mold in this invention is not limited for three pinholes. Four or more pinholes can make the same positioning function between the carrier film and the mold. Similarly, the positioning between the mold 20 and the plate 10 is not limited to three up position pins 40 and three down position holes 12. As long as the up position pins of the mold and the down position holes have the same numbers and positions, four or more up position holes and down position holes can also reach the positioning function between the mold 20 and the plate 10.

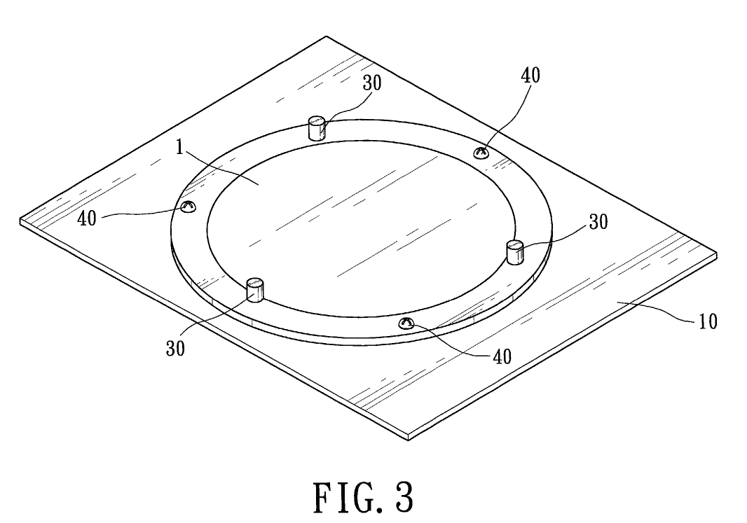

Please refer to FIG.3, the following steps are to set up all laser process equipment and adjust the laser parameters. First insert the aforesaid three pins 30 into the three pin holes 21 and cover the aforesaid test carrier film 1 with a dustless paper and fix it on the aforesaid mold 20 to make the aforesaid three pins 30 top touch the aforesaid carrier film 1 edge so that the positioning between the carrier film 1 and the mold 20 can be finished. Then insert the aforesaid mold 20 up position pins 40 into the down position holes 12 on the plate 10 to finish the positioning between the aforesaid mold 20 and the plate 10.

Then start the laser head, adjust the laser parameters, and conduct laser process. After finishing, remove the aforesaid carrier film 1, check the vacuum hole dimension and surface process condition. If it's necessary, the laser process and the dimension/surface check procedures must be repeated to reach the optimal dimensions/surface check results result. And find out the optimal laser process parameters in this step. The aforesaid laser process parameters include laser power, laser process time, gas blowing pressure and the distance from the laser to the carrier film 1. The most important of them are laser power and laser process time. The carrier film thickness depends on the real application of the CMP machine so the aforesaid laser power and process time vary with different applications. If the laser power and the process time is not enough, the aforesaid vacuum holes cannot be pierced through; but if the laser power and the process time is too much, the aforesaid vacuum hole outer edge is easy to be destroyed and make the poor carrier film surface flatness so it can not be applied on the CMP machine. Take the 8-inch wafer as an example, the aforesaid carrier film 1 thickness is between 0.5 to 2 mm, the optimal thickness is about 0.76 mm. For the carrier film with 0.76 mm thickness, the aforesaid laser power is about 50 to 200 watts, the optimal laser power is about 100 watts. The process time for each vacuum hole is between 0.5 and 5 seconds, the optimal process time is about 2 seconds.

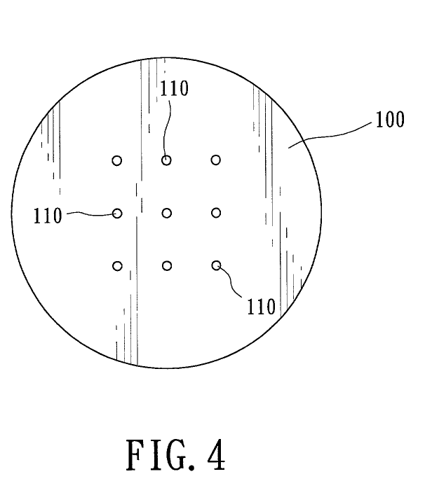

Then please refer to FIG.4. After adjusting each laser parameter, replace the aforesaid test carrier film 1 with the real process carrier film 100 that will be conducted by laser to form vacuum holes. As shown in FIG.4, after laser process, there are plural vacuum holes 110 formed which have smooth edges and same diameters on the carrier film 100. The aforesaid vacuum hole 110 diameter is to match the vacuum hole diameter on the wafer carrier on the CMP machine. The method of vacuum holes formation on carrier film of chemical mechanical polishing machine in this invention is finished here.

It may thus be seen that the objects of the present invention set forth herein, as well as those made apparent from the foregoing description, are efficiently attained. While the preferred embodiments of the invention have been set forth for purpose of disclosure, modifications of the disclosed embodiment of the invention as well as other embodiment thereof may occur to those skilled in the art. Accordingly, the appended claims are intended to cover all embodiments that do not depart from the spirit and scope of the invention.

What is claimed is:

1. A method of vacuum holes formation on carrier film of chemical mechanical polishing machine, the formed vacuum holes are to match the vacuum hole dimensions and positions of wafer carrier on chemical mechanical polishing machine; the characteristic is that the aforesaid vacuum holes are formed by laser process.

2. A method of vacuum holes formation on carrier film of chemical mechanical polishing machine, which includes the following steps:
(a) provide a test carrier film;
(b) provide a plate, a light passing window and plural down position holes are formed on the aforesaid plate;
(c) provide a mold, plural pin holes, plural up position holes, plural laser through holes are formed on the aforesaid mold, and plural up position pins are fixed inside the aforesaid up position holes; the aforesaid pin hole position is to match the aforesaid test carrier film outer diameter; the aforesaid up position pin numbers are the same with the down position hole numbers on the aforesaid plate;
(d)place the aforesaid test carrier film on the aforesaid mold and finish positioning, then fix the aforesaid mold on the aforesaid plate and positioning, and fix the aforesaid plate on the laser process machine;
(e) adjust the laser parameters; and
(f) replace with the carrier film for processing and do laser process, form plural vacuum holes on the aforesaid carrier film.

3. The method of vacuum holes formation on carrier film of chemical mechanical polishing machine as claimed in claim 2, wherein after providing a test carrier film, it includes a step of measuring the aforesaid test carrier film appearance dimension.

4. The method of vacuum holes formation on carrier film of chemical mechanical polishing machine as claimed in claim 2, wherein the aforesaid light passing window is circle structure, its diameters are smaller than that of the carrier film, while its diameters are large enough to cover the vacuum holes area on the carrier film.

5. The method of vacuum holes formation on carrier film of chemical mechanical polishing machine as claimed in claim 2, wherein the aforesaid test carrier film is fixed and positioned on the aforesaid mold; the aforesaid plural pins are inserted into the aforesaid pin holes and the aforesaid test carrier film is covered by a dustless paper and fixed on the aforesaid mold to make the aforesaid plural pins touching the aforesaid carrier film edge so that the positioning between the carrier film and the mold can be finished.

6. The method of vacuum holes formation on carrier film of chemical mechanical polishing machine as claimed in claim 2, wherein the aforesaid mold is fixed on the aforesaid plate and positioned, that is inserting the up position pins of the aforesaid mold into the down position holes of the plate to finish the positioning between the aforesaid mold and the plate.

7. The method of vacuum holes formation on carrier film of chemical mechanical polishing machine as claimed in claim 2, wherein the aforesaid laser parameters adjustment includes starting the laser head, adjusting the laser parameters, laser processing; check the vacuum hole dimension and surface process condition after finishing; the laser process and dimension/surface check steps are repeated to reach the best dimensions/surface check results and find out the optimal laser parameters.

8. The method of vacuum holes formation on carrier film of chemical mechanical polishing machine as claimed in claim 2, wherein the aforesaid laser parameters include laser power, laser processing time, blowing pressure, laser distance and carrier film distance.

9. The method of vacuum holes formation on carrier film of chemical mechanical polishing machine as claimed in claim 8, wherein the aforesaid laser power is about between 50 and 200 watts, the optimal laser power is 100 watts.

10. The method of vacuum holes formation on carrier film of chemical mechanical polishing machine as claimed in claim 2, wherein the aforesaid process time is between 0.5 and 5 seconds, the optimal process time is 2 seconds.

11. A method of vacuum holes formation on carrier film of chemical mechanical polishing machine, which includes the following steps:
(a) provide a test carrier film;
(b)provide a plate, a light passing window and three down position holes are formed on the aforesaid plate;
(c) provide a mold, three pin holes, three up position holes, plural laser through holes are formed on the aforesaid mold, and three up position pins are fixed inside the aforesaid three up position holes; the aforesaid pin hole position is to match the aforesaid test carrier film outer diameter;
(d)place the aforesaid test carrier film on the aforesaid mold and finish positioning, then fix the aforesaid mold on the aforesaid plate and positioning, and fix the aforesaid plate on the laser process machine;
(e) adjust the laser parameters; and
(f) replace with the carrier film for processing and do laser process, form plural vacuum holes on the aforesaid carrier film.

12. The method of vacuum holes formation on carrier film of chemical mechanical polishing machine as claimed in claim 11, wherein after providing a test carrier film, it includes a step of measuring the aforesaid test carrier film appearance dimension.

13. The method of vacuum holes formation on carrier film of chemical mechanical polishing machine as claimed in claim 11, wherein the aforesaid light passing window is circle structure, its diameters are smaller than that of the carrier film, while its diameters are large enough to cover the vacuum holes area on the carrier film.

14. The method of vacuum holes formation on carrier film of chemical mechanical polishing machine as claimed in claim 11, wherein the aforesaid test carrier film is fixed and positioned on the aforesaid mold; the aforesaid plural pins are inserted into the aforesaid pin holes and the aforesaid test carrier film is covered by a dustless paper and fixed on the aforesaid mold to make the aforesaid plural pins touching the aforesaid carrier film edge so that the positioning between the carrier film and the mold can be finished.

15. The method of vacuum holes formation on carrier film of chemical mechanical polishing machine as claimed in claim 11, wherein the aforesaid mold is fixed on the aforesaid plate and positioned, that is inserting the up position pins of the aforesaid mold into the down position holes of the plate to finish the positioning between the aforesaid mold and the plate.

16. The method of vacuum holes formation on carrier film of chemical mechanical polishing machine as claimed in claim 11, wherein the aforesaid laser parameters adjustment includes starting the laser head, adjusting the laser parameters, laser processing; check the vacuum hole dimension and surface process condition after finishing; the laser process and dimension/surface check steps are repeated to reach the best dimensions/surface check results and find out the optimal laser parameters.

17. The method of vacuum holes formation on carrier film of chemical mechanical polishing machine as claimed in claim 11, wherein the aforesaid laser parameters include laser power, laser processing time, blowing pressure, laser distance and carrier film distance.

18. The method of vacuum holes formation on carrier film of chemical mechanical polishing machine as claimed in claim 17, wherein the aforesaid laser power is about between 50 and 200 watts, the optimal laser power is 100 watts.

19. The method of vacuum holes formation on carrier film of chemical mechanical polishing machine as claimed in claim 17, wherein the aforesaid process time is between 0.5 and 5 seconds, the optimal process time is 2 seconds.

20. A method of vacuum holes formation on carrier film of chemical mechanical polishing machine, which includes the following steps:
(a) a plate, a light passing window and plural down position holes are formed on the aforesaid plate;
(b) a mold, plural pin holes, plural up position holes, plural laser through holes are formed on the aforesaid mold, and plural up position pins are fixed inside the aforesaid plural up position holes; the aforesaid pin hole position is to match the aforesaid test carrier film outer diameter;
(c)plural pins, the aforesaid pin numbers and dimensions match the aforesaid pinholes.
(d)the aforesaid test carrier film is fixed on the aforesaid mold and its positioning method is to insert aforesaid plural pins into plural pin holes to make the aforesaid plural pins touching the aforesaid carrier film edges so that the positioning between the carrier film and the mold can be finished; and
(e) the aforesaid mold is fixed on the aforesaid plate, its positioning method is to insert the aforesaid up position pins of the mold into the down position holes of the plate to finish the positioning between the mold and the plate.
